(19) United States
(12) Patent Application Publication
(10) Pub. No.: US 2007/0160182 A1
(43) Pub. Date: Jul. 12, 2007

(54) Telecommunications system indicator and protector

(76) Inventors: Leon Kotze, Kliprvier (ZA); Alexander Richter, Muldersdrift (ZA)

Correspondence Address: LADAS & PARRY LLP, 224 SOUTH MICHIGAN AVENUE, SUITE 1600, CHICAGO, IL, 60604, US

(21) Appl. No.: 10/583,496

(22) PCT Filed: Dec. 17, 2004
(86) PCT No.: PCT/IB04/04175

§ 371 Date: Jul. 24, 2006

(30) Foreign Application Priority Data
Dec. 19, 2003 (ZA) 2003/9858
Jan. 19, 2004 (ZA) 2004/0376
Jan. 23, 2004 (ZA) 2004/0527

(51) Int. Cl. H04M 1/24; H04M 3/08; H04M 3/22

(52) U.S. Cl. 379/1.01; 379/33

(57) ABSTRACT

The present invention provides a telecommunications system indicator and protector (10) for indicating the working status of a telecommunications line (16) and of equipment (12, 14) which can be connected to the telecommunications line. The telecommunications system indicator includes connecting means whereby the telecommunications system indicator can be connected to the telecommunications line and the equipment respectively, a line testing circuit (Block B) and an equipment testing circuit (Block A). The telecommunications system indicator further also includes a switch (18) which is movable between a first position wherein the telecommunications line is connected to the line testing circuit and a second position wherein the telecommunications line is connected to the equipment testing circuit as well as an indicator for indicating whether the telecommunications line is in working order when the switch is located in the first position, and whether the equipment is in working order when the switch is located in the second position.

### BACKGROUND TO THE INVENTION

This invention relates to a telecommunications system indicator and protector.

End users of fixed line telecommunications service providers are often confronted with the problem of establishing whether a breakdown in communication is attributable to a problem on the side of the telecommunications service provider or due to faulty equipment of the end user. Invariably an end user will first contact his service provider to request a technician to be sent out to inspect the telecommunications link. In many instances the technician will inform the user that the link is working and that the breakdown in communication is due to faulty equipment. This is an undesirable state of affairs for a number of reasons. These include that time is wasted in waiting for a technician to be sent to attend to a call-out and that unnecessary costs are incurred in order to re-establish communication.

Owners of switchboards have in the past had the problem of identifying whether all their telecommunications lines are in working order. For example, a firm may rent ten telecommunications lines from a fixed line telecommunications service provider, but due to a problem on the side of the service provider, only eight lines are in working order. As it will rarely happen that all eight lines are required simultaneously, the firm will never become aware of the problem and that it is in effect paying rent for two lines which can not be used.

Lightning is a constant threat to telecommunications equipment and there is a constant demand for equipment which can provide protection against lightning. To date lightning protection systems have made use of earth-based circuitry. In a number of instances such circuitry has proven not to be effective as lightning found alternative routes via the earth connection of the circuitry to the equipment, thereby causing severe damage. It is therefore envisaged that a demand may exist under users of fixed line telecommunications services for an apparatus which will enable them to determine the working status of their telecommunications lines and that of their telecommunications equipment, while simultaneously providing means for protecting the telecommunications equipment against lighting and power surges.

It is an object of the invention to address the above problems.

### SUMMARY OF THE INVENTION

According to the present invention there is provided a telecommunications system indicator and protector for indicating the working status of a telecommunications line and of equipment which can be connected to the telecommunications line, the telecommunications system indicator and protector including:
connecting means whereby the telecommunications system indicator and protector can be connected to the telecommunications line and the equipment respectively;
a line testing circuit;
an equipment testing circuit;
a switch, the switch being movable between a first position wherein the telecommunications line is connected to the line testing circuit and a second position wherein the telecommunications line is connected to the equipment testing circuit; and
an indicator for indicating whether the telecommunications line is in working order when the switch is located in the first position, and whether the equipment is in working order when the switch is located in the second position.

In a first embodiment of the invention the indicator is provided by a light source which emits light to indicate that the telecommunications line is in working order when the switch is located in the first position and wherein the light source emits light to indicate that the equipment is in working order when the switch is located in the second position.

In the first embodiment of the invention the light source is a light emitting diode.

Preferably the switch is movable to a third position wherein the telecommunications line is disconnected from both the line testing circuit and the equipment testing equipment.

Advantageously the equipment testing circuit includes a lightning protector for protecting the equipment against lighting surges.

Typically the connecting means can be connected to a modem, a telephone, a fax machine a PABX system, a power dialer, an ISDN/ASDL box, an alarm and/or a remote dial-up modem.

Preferably the equipment testing circuit is non-earthed.

According to a further aspect of the present invention there is provided a telecommunications system indicator and protector comprising:
connecting means whereby the telecommunications system indicator and protector can be connected to a telecommunications line and to equipment respectively;
a non-earthed equipment testing circuit for connecting the connecting means of the telecommunications line with the connecting means of the equipment, the non-earthed equipment testing circuit including a lightning protector; and
an indicator for indicating whether the lightning protector is in working order.

### BRIEF DESCRIPTION OF THE DRAWINGS

The invention will now be described in more detail, by way of example only, with reference to the following drawings wherein:

FIG. 1 shows a schematic representation of a telecommunications system indicator and protector according to the present invention connected to a telecommunications line at one end and to telecommunications equipment at the other end;

FIG. 2 shows a circuit diagram of a first embodiment of the telecommunications system indicator and protector;

FIG. 3 shows a circuit diagram of a second embodiment of a telecommunications system indicator and protector according to the invention;

FIG. 4 shows a circuit diagram of a third embodiment of a telecommunications system indicator and protector according to the invention; and

FIG. 5 shows a circuit diagram of a fourth embodiment of a telecommunications system indicator and protector in accordance with the present invention.

### DESCRIPTION OF THE ILLUSTRATED EMBODIMENTS

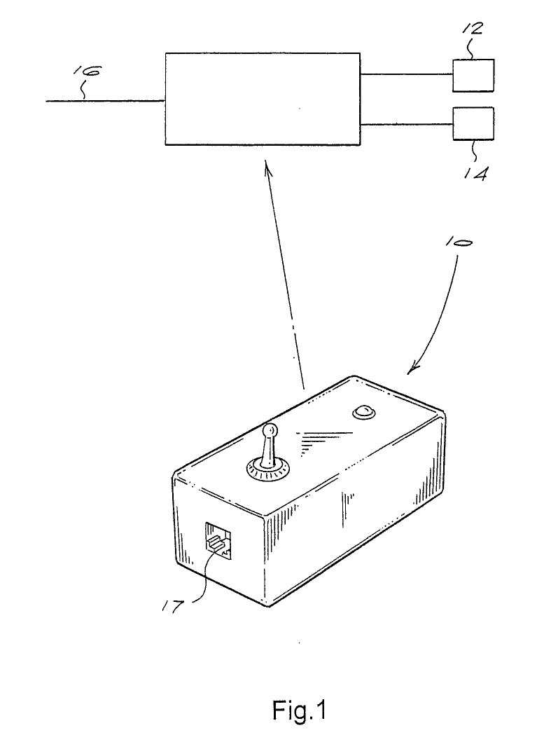

FIG. 1 shows a telecommunications system indicator and protector 10 according to the invention connected at one end thereof to telecommunications equipment, here a modem 12 and a telephone 14, and to a telecommunications connection 16 of a fixed line telecommunications service provider at the other. The telecommunications connection in this description is a telephone line and persons skilled in the field of telecommunication will be aware of the fact that an alternating current flows through the telephone line for facilitating communication.

The telecommunications systems indicator and protector 10 is connected to the telecommunications equipment through connecting means provided by three RJ11 plugs, one of which is shown and indicated with the reference numeral 17.

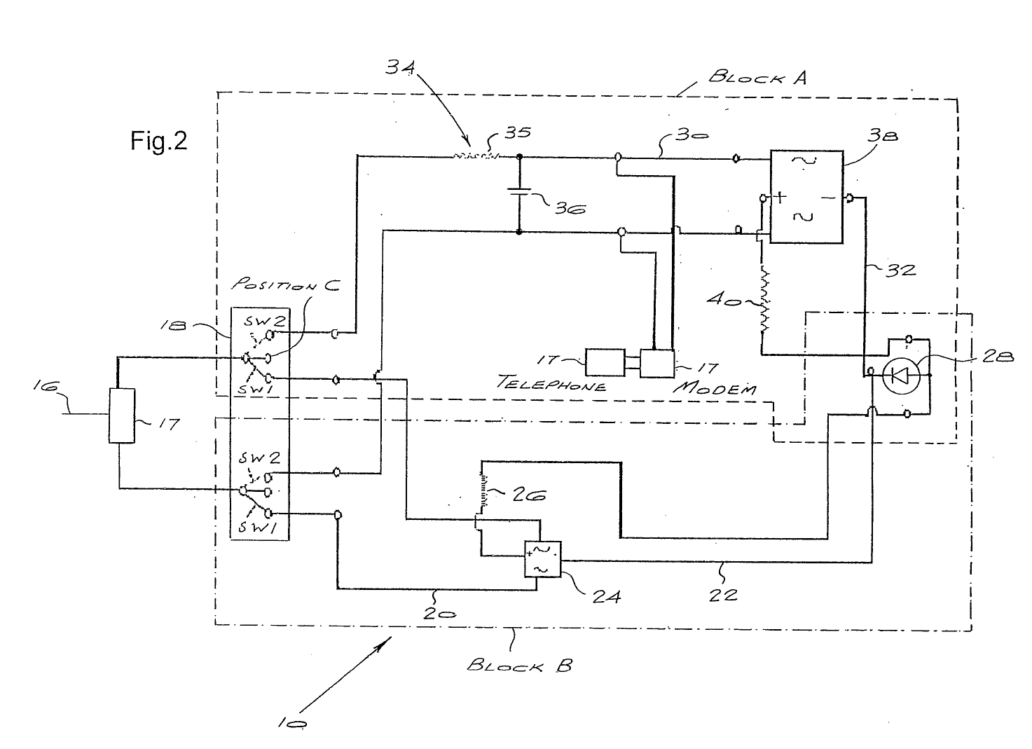

According to a first embodiment of the invention, shown in FIG. 2, the telecommunications system indicator and protector 10 comprises a switch 18 which is movable between different positions thereby to connect the telecommunications connection 16 to different circuits, indicated respectively as Block A, Block B and Position C.

With the switch 18 in its first position SW1 the telecommunications connection 16 is connected to a line testing circuit, indicated as Block B, comprising an alternating current (AC) circuit 20 and a direct current (DC) circuit 22. A rectifier 24 is provided for converting alternating current of the AC line testing circuit 20 to a direct current which can flow in the DC line testing circuit 22. The DC line testing circuit 22 comprises a resistor 26, which is used for regulating current therein, and an indicator, in this embodiment a light source in the form of a light emitting diode (LED) 28.

To test whether the telecommunications connection 16 is faulty, a user moves the switch 18 of the telecommunications system indicator and protector 10 to the first position SW1. In the event of the telecommunications connection being in working order, alternating current flows from the telecommunications connection 16 through the switch 18 to the line testing circuit (Block B). In the line testing circuit the alternating current flows through the rectifier 24, closing the AC line testing circuit 20, thereby allowing the rectifier 24 to convert alternating current from the AC line testing circuit 20 to direct current in the DC line testing circuit 22. This provides current to the LED 28, causing it to emit light. If the telecommunications connection 16 is faulty as a result of a line fault in the telecommunications network, no current flows from the telecommunications connection 16. This causes an open circuit in the AC line testing circuit 22 resulting in no current flow in the DC line testing circuit 22. Ultimately the LED 28 does not emit light thereby indicating to a user that there is a problem on the side of the telecommunications service provider.

Moving the switch 18 to its second position SW2 provides a connection between the telecommunications connection 16 and the equipment testing circuit (Block A). The equipment testing circuit comprises an AC equipment testing circuit 30 and a DC equipment testing circuit 32. The AC equipment testing circuit 30 includes a lighting protector, generally indicated with the reference 34, provided by a resistor 35 which is connected to a capacitor 36. The capacitor 36 is parallel connected to the equipment testing circuit (Block A) allowing it to protect the circuit from over currents in the form of spikes or surges. The AC equipment testing circuit 30 further comprises a rectifier 38 for converting alternating current in the AC equipment testing circuit 30 to direct current in the DC equipment testing circuit 32. The rectifier 38 is further connected to a resistor 40 for regulating current to the LED 28.

To test whether his equipment is faulty a user moves the switch 18 of the telecommunications system indicator and protector 10 to the second position SW2. If the telecommunications connection is in working order, current flows therefrom through the resistor 34 and to the modem 12 and the telephone 14. With the modem 12 and telephone 14 in working order, the rectifier 38 forms part of a closed circuit thereby allowing the rectifier 38 to convert alternating current from the AC equipment testing circuit 30 to direct current in the DC equipment testing circuit 32. With current flowing in the DC equipment testing circuit 32, the LED 28 emits light thereby indicating to the user that the equipment is in working order. Should either the modem 12 or telephone 14 however be faulty, an open circuit will result in the AC equipment testing circuit 30 preventing any current from flowing in the DC equipment testing circuit 32. This will result in no light being emitted by the LED 28.

The switch 18 is also movable to an open position (position C), wherein the telecommunications connection 16 is disconnected from the equipment testing circuit and the line testing circuit such that the equipment is thereby protected against surges caused by, for example, lightning.

Although not shown it is envisaged that a fuse may be incorporated with the resistor 36 such that the lighting protector 34 comprises the resistor 35 and the fuse which in turn is connected to the capacitor 36.

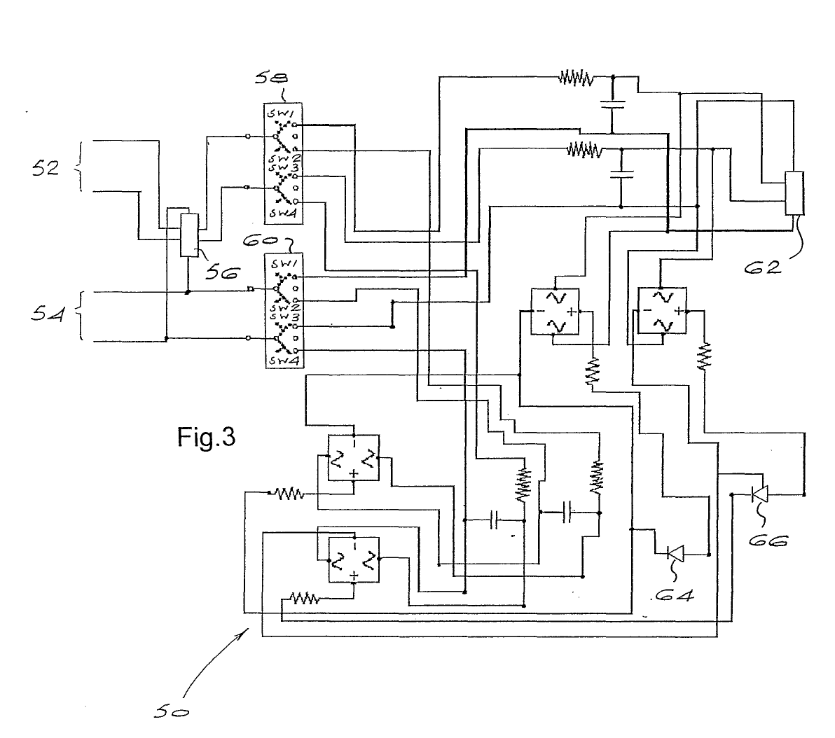

In FIG. 3 a second embodiment of the telecommunications system indicator and protector is shown, generally indicated with the reference numeral 50. The telecommunications system indicator and protector 50 is provided for accommodating a four-wire telecommunications line, for example a 4-Wire E/M PABX Tieline where typically one pair of lines is used for audio transmission and audio reception, and the other pair is used for signaling.

As shown the telecommunications connection here comprises a first telecommunications line pair 52 and a second telecommunications line pair 54 which is connected to the telecommunications system indicator and protector 50 via a connecting means, here in the form of a RJ45 plug indicated with the reference numeral 56. It will be appreciated by persons skilled in the field of telecommunications that the telecommunications system indicator and protector 50 operates on a principle similar to the telecommunications system indicator and protector 10. In the case of the telecommunications system indicator and protector 50, however, two switches 58 and 60 are provided for switching between alternative line testing circuitry for testing whether the telecommunications line pairs 52 and 54 are in working order, and equipment testing circuitry for testing whether equipment which is connected at connecting means 62, here also a RJ45 plug, is in working order.

To test whether equipment which is connected to the connecting means 62 is in working order, the switches 58 and 60 are located in their positions SW1. Should the equipment be in working order an indicator will provide an indication to this effect, in this embodiment an LED 64 is used for emitting light as an indication of working order. Similarly, if the switches 58 and 60 are located in their positions SW3 another indicator, also in the form of an LED and now indicated with the reference numeral 64, will emit light if the equipment is in working order.

To test whether the telecommunications line is in working order the switches 58 and 60 are located in their positions SW2 such that the LED 64 will emit light if the telecommunications line is in working order. Similarly the LED 64 will light up when the switches 58 and 60 are located in their positions SW4 and should the telecommunications connection be in working order.

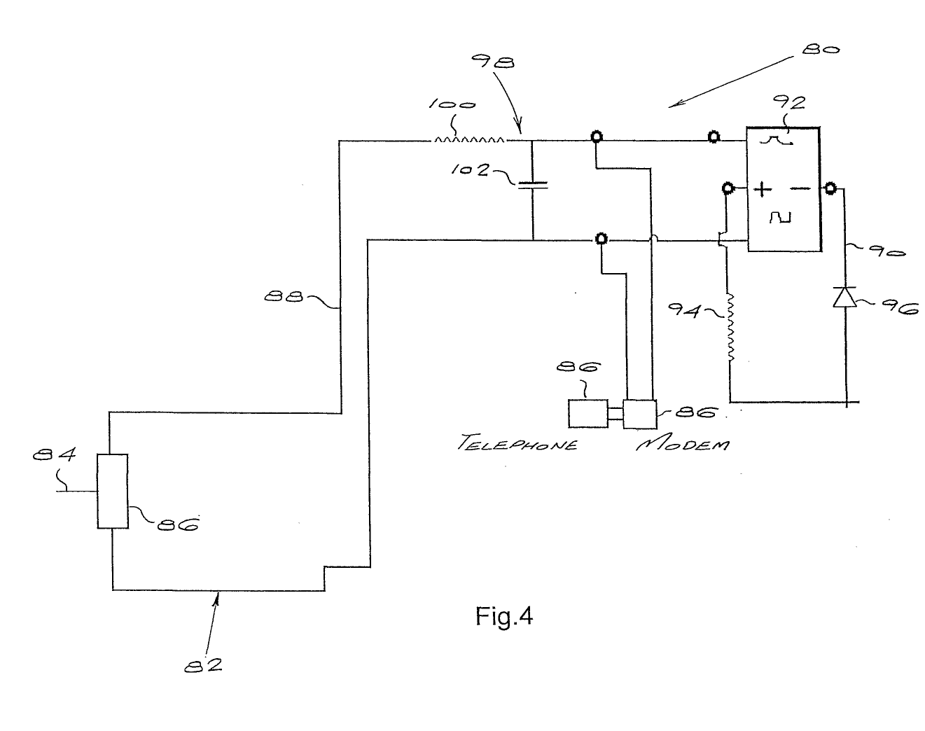

FIG. 4 shows a third embodiment of a telecommunications system indicator and protector in accordance with the present invention generally indicated with the reference numeral 80. The telecommunication system indicator and protector 80 comprises an equipment testing circuit, which is equivalent to the equipment testing circuit indicated by the Block A in FIG. 2, with the exception that the switch 18 has been removed. Here the line testing circuit is indicated with the reference numeral 82.

The telecommunications system indicator and protector 80 is shown to be connected to telecommunications equipment, here a modem and a telephone, at one end and to a telecommunications connection 84 of a fixed line telecommunications service provider at the other. As in the first embodiment of the invention the telecommunications connection 84 is a telephone line and the equipment and telephone line is connected to the telecommunications system indicator and protector 80 with the use of three RJ11 plugs 86.

It is pointed out that the equipment testing circuit 82 is not earthed and will act as a protection circuit as will be explained below.

The line testing circuit 82 comprises an alternating current (AC) circuit 88 and a direct current (DC) circuit 90. A rectifier 92 is provided between these circuits for converting the alternating current of the AC circuit 88 to a direct current which can flow through the DC circuit 90. The DC circuit 90 comprises a resistor 94 which regulates current flowing therein, and an indicator 96, here in the form of a light emitting diode (LED). The AC circuit 88 comprises a lightning protector 98. In this embodiment the lighting protector 98 is provided by a resistor 100 and a capacitor 102, here a 2 kV capacitor.

Under normal working conditions alternating current flows from the telecommunications connection 84 through the AC circuit 88 and through the rectifier 92, closing the AC circuit, thereby allowing the rectifier 92 to convert alternating current from the AC circuit to direct current in the DC circuit 90. This provides current to the LED 96, causing it to emit light thereby indicating to the user that the telecommunications system indicator and protector 80 is in working order and that it can provide protection against lighting surges entering through the telecommunications connection 84.

In the event that lighting strikes a network of the telecommunications service provider such that a lightning surge is conducted to the telecommunications connection 84 such that either the rectifier 92, the capacitor 102 or the LED will be destroyed thereby creating an open circuit and preventing any current to flow to either the equipment. It is pointed out that the magnitude of the surge will determine which components will be destroyed. It will be appreciated that when such an event has taken place the dial tone of an incoming line will be removed.

It is further pointed out that the magnitude of the surge will determine whether the LED will cease to emit light completely or emit light of dimmed intensity, to indicate to the user that the telecommunications system indicator and protector 80 has been damaged and that it should be replaced.

It will be appreciated by persons skilled in the field of telecommunications that the telecommunications system indicator and protector 50 of FIG. 3 can be changed in a similar manner to provide a non-earthed circuit for providing protection against lightning surges.

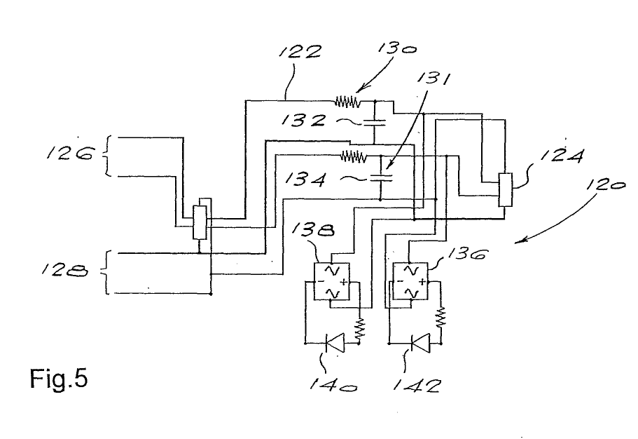

FIG. 5 shows a fourth embodiment of a telecommunications system indicator and protector 120 of the invention. This embodiment of the invention is similar to the telecommunications system indicator and protector 50 with the exception that the switches 58 and 60 have been removed. The telecommunications system indicator and protector 120 includes a non-earthed equipment testing circuit 122 which is connected to the connecting means 124 such that telecommunication equipment which are connected to the connecting means 124 will be protected against lightning surges coming through a telecommunications line pair 126 and 128 by lightning protectors, provided by capacitors 132 and 134 which will be destroyed to create an open circuit before the surge can be conducted to the equipment. The equipment testing circuit 122 also includes rectifiers 136 and 138 and it is pointed out that a large surge entering the line testing circuit will either destroy the capacitors 132 and 134, the rectifiers 136 and 138 or both the capacitors and the rectifiers, thereby preventing the surge from reaching the equipment.

When the telecommunications system indicator and protector 120 is in working order indicators will provide an indication to that effect, here again in the form of LED's 140 and 142 which will emit light. Where the telecommunications system indicator and protector 120 has however taken a lightning hit, either one or both the LED's will cease to emit light or dim in comparison to normal conditions thereby indicating to a user that the telecommunications system indicator and protector 120 should be replaced.

It will be appreciated that the telecommunications system indicator and protector described above can be adapted to test larger numbers of telecommunications lines. This is achieved by simply adding a new line testing circuit and equipment testing circuit for each new line, as well as an additional LED. Such a configuration will typically be used for a switchboard.

It will be appreciated that various electrical light sources, and not just LED's, could be used in the telecommunications system indicator and protector of the invention.

The telecommunications system indicator and protector has the advantage that it can indicate whether a fault is located on the telecommunications line of the service provider or in the equipment of a user. This is beneficial as the user would be able to notify the telecommunications service provider when the fault is located on the side of the telecommunications service provider without requiring a technician to respond to a call-out.

Another advantage is that the status of telecommunications lines can be monitored 24 hours a day such that faulty lines can be identified immediately. The telecommunications system indicator and protector further provides an option of disconnecting equipment from the telecommunications line, especially when the service provider is required to test the line. The telecommunications system indicator and protector is compact, cost-effective and as the indicator and protector is connected to the telecommunications network, no additional power supply is necessary to power it.

It is pointed out that the telecommunications system indicator and protector 10 of the first embodiment of the invention and the telecommunications system indicator and protector 80 of the third embodiment of the invention can be used in combination to provide protection against lightning surges. It will be appreciated that a similar arrangement is possible for accommodating a four-line telecommunications line.

It Is finally pointed out that the telecommunications system indicator and protector which is described above will continue to protect telecommunications equipment connected thereto even in the event where it has been hit by a power surge.

A telecommunications system indicator and protector in accordance with the present invention addresses the problems identified in the background portion of the specification.

1. A telecommunications system indicator and protector for indicating the working status of a telecommunications line and of equipment which can be connected to the telecommunications line, the telecommunications system indicator and protector including:
connecting means whereby the telecommunications system indicator and protector can be connected to the telecommunications line and the equipment respectively;
a line testing circuit;
an equipment testing circuit;
a switch, the switch being movable between a first position wherein the telecommunications line is connected to the line testing circuit and a second position wherein the telecommunications line is connected to the equipment testing circuit; and
an indicator for indicating whether the telecommunications line is in working order when the switch is located in the first position, and whether the equipment is in working order when the switch is located in the second position.

2. A telecommunications system indicator and protector according to claim 1 wherein the connecting means includes an RJ11 plug.

3. A telecommunications system indicator and protector according to claim 1 wherein the connecting means includes an RJ45 plug.

4. A telecommunications system indicator and protector according to claim 1 wherein the equipment testing circuit includes a lightning protector for protecting the equipment against lighting surges.

5. A telecommunications system indicator and protector according to claim 4 wherein the lightning protector comprises a capacitor.

6. A telecommunications system indicator and protector according to claim 4 wherein the lightning protector includes a fuse.

7. A telecommunications system indicator and protector according to claim 1 wherein the line testing circuit comprises an alternating current circuit and a direct current circuit.

8. A telecommunications system indicator and protector according to claim 1 wherein the equipment testing circuit comprises an alternating current circuit and a direct current circuit.

9. A telecommunications system indicator and protector according to claim 1 wherein the indicator is a light source which emits light to indicate that the telecommunications line is in working order when the switch is located in the first position and wherein the light source emits light to indicate that the equipment is in working order when the switch is located in the second position.

10. A telecommunications system indicator and protector according to claim 9 wherein the light source is a light emitting diode.

11. A telecommunications system indicator and protector according to claim 1 wherein the equipment testing circuit is non-earthed.

12. A telecommunications system indicator and protector according to claim 1 wherein the connecting means can accommodate a four wire telecommunications line.

13. A telecommunications system indicator and protector according to claim 1 wherein the switch is movable to a position wherein the, telecommunication line is disconnected from both the line testing circuit and the equipment testing circuit.

14. A telecommunications system indicator and protector according to claim 1 wherein the connecting means can be connected to a modem, a fax machine, a telephone, a PABX system, a power dialer, an ISDN/ASDL box, an alarm and/or a remote dial-up modem.

15. A telecommunications system indicator and protector comprising:
connecting means whereby the telecommunications system indicator and protector can be connected to a telecommunications line and to equipment respectively;
a non-earthed equipment testing circuit for connecting the connecting means of the telecommunications line with the connecting means of the equipment, the non-earthed equipment testing circuit including a lightning protector; and
an indicator for indicating whether the lightning protector is in working order.

16. A telecommunications system indicator and protector according to claim 15 wherein the lightning protector comprises a capacitor.

17. A telecommunications system indicator and protector according to claim 16 wherein the capacitor is a 2 kV capacitor.

18. A telecommunications system indicator and protector according to claim 15 wherein the lightning protector includes a fuse.

19. A telecommunications system indicator and protector according to claim 15 wherein the indicator is a light source.

20. A telecommunications system indicator and protector according to claim 19 wherein the light source is a light emitting diode.

21. A telecommunications system indicator and protector according to claim 15 wherein the equipment testing circuit comprises a direct current circuit and an alternating current circuit.

22. A telecommunications system indicator and protector according to claim 15 including a rectifier for converting alternating current to direct current.
